(19) United States
(12) Patent Application Publication
(10) Pub. No.: US 2011/0196753 A1
(43) Pub. Date: Aug. 11, 2011

(54) System and method for immediate issuance of an activated prepaid card with improved security measures

(76) Inventors: Brian Joseph Hodgdon, Saddle Brook, NJ (US); James H. Grabow, Newport Beach, CA (US)

(21) Appl. No.: 12/658,598

(22) Filed: Feb. 9, 2010

(51) Int. Cl. G06Q 40/00; G06F 17/30

(52) U.S. Cl. 705/16; 705/41; 707/705; 707/E17.044

(57) ABSTRACT

A system and method for immediate issuance of a prepaid transaction card having increased security measures. The identity of the applicant is verified and checked against a database in accordance with Customer Identification Program, Sarbanes-Oxley and the USA Patriot Act in real time. Authorized applicants receive a printed prepaid debit card bearing name and photograph immediately at the point of sale.

### FIELD OF THE INVENTION

The present invention generally relates to the field of prepaid consumer card transactions. More specifically, the present invention relates to a system and method for providing immediate issuance of an activated prepaid/debit card at a point of sale. The presently disclosed system and method provides for improved security measures, including the immediate issuance of a prepaid card bearing a purchaser's name, picture, and other identifying indicia.

### BACKGROUND OF THE INVENTION

For the past several decades, consumers have been presented with many different payment options when transacting business, including payment via government-issued legal tender (e.g., United States dollar or the European Union Euro), payment via a personal check/cheque or other commercial paper linked to a banking/financial institution, and payment via credit cards, payment via prepaid cards, and payment via debit cards. While credit cards (often also referred to as “charge cards”) allow a consumer to spend money tied to a credit line offered by the issuing bank, a debit card (often also referred to as a “check card” or “bank card”) is typically linked to an account containing funds (i.e., a non-zero monetary balance). A debit card allows a user to spend only the funds contained within that account and no extension of credit is required and as such can be functionally equated to an “electronic check.” Similarly, a prepaid card allows a user to spend only the funds associated with the remaining balance of the particular card. As electronic payments are fast becoming the primary means for conducting financial transactions, the use of credit cards, prepaid cards, and debit cards is widely recognized. It has been estimated that debit transactions will overtake cash purchases by the year of this filing as the primary method of payment by consumers (See “How Visa, Using Card Fees, Dominates a Market,” Martin, Andrew, The New York Times, Jan. 5, 2010). The use of prepaid cards and debit cards even allows the user to take advantage of the credit card processing networks and related systems already in use at various merchants and the like.

There are several types of debit card systems in use worldwide today including Electronic Purse Debit, Prepaid Debit Card Systems (e.g., gift cards and telephone cards), Online Debit Systems (often referred to as “PIN-debit”), and Offline Debit Systems (often referred to as “Signature-debit”).

The Electronic Purse Debit system, while not currently utilized in the United States is in use in numerous European nations. This system performs in a manner similar to that of the Offline and Online systems without the requirement of a network. Specifically, an “electronic purse” (a storage means on a card chip) stores a pre-set value which is electronically depleted based on a user's purchase until the value is registered as zero. In this fashion, no network connection is required to verify a balance.

Prepaid Debit cards are readily available to consumers in the United States and in international markets. A purchaser of a Prepaid card (e.g., a telephone calling card, gift card, etc.) either purchases the card in a specified monetary amount or is entitled to “load” a specific amount of funds into an account associated with a card. Prepaid cards can be operated using either the Online Debit System or Offline Debit System. Individual users of prepaid cars typically do not have a demand deposit account relationship with the financial institution issuing the card or holding the funds associated with the card. A typical prepaid card allows a user to “reload” or “refresh” funds by providing additional funds to the account. The value of the card, dictated by the user, can be stored as data in the memory of the card. As an alternative, information relating to the user's account can be stored within a magnetic stripe, or an integrated circuit, located on certain prepaid cards. In connection with this alternative, the account information is typically stored on a host computer and can be accessed through a network by utilizing the information stored in the magnetic stripe. Importantly, verification of the identity of the user of a prepaid card is not required, making the prepaid card a bearer instrument.

Prepaid cards have long been issued by particular merchants in the form of gift cards. These specific gift cards can only be used when purchasing goods or services from the merchant that issued the card. Cards are typically offered in specific predetermined amounts, and may or may not be activated prior to purchase. No verification measures are typically employed when purchasing gift cards and personal information related to the bearer of such cards is not presented on the card. It is well documented in the art that if a prepaid card is activated prior to purchase, the card can be stolen and used immediately to make purchases. As such these types of cards present an inherent flaw and can be very risky for merchants without fail-safe systems in place to monitor transactions of this nature.

Once purchased, the process for using such a prepaid card involves the user presenting the card at the point of sale for payment for goods and/or services offered by the merchant. An attendant at the point of sale enters the card information which is verified using a terminal networked to a host computer. Once verified according to certain pre-determined transaction rules, the monetary amount of the purchase is debited from the account associated with the card. Once the value of the account is debited to zero, the card is typically discarded.

As commonly known in the art, the above-described prepaid card system and method has several disadvantages. First, prepaid cards offered through the above-described system (usually referred to as “gift cards”) are typically only offered for purchase in predetermined amounts and do not allow a user to specify an amount. Second, the gift cards are generally discarded after use because they are not replenishable. Next, gift cards purchased from a particular merchant are only redeemable for goods and/or services provided by the specified merchant. Further, as mentioned, gift cards are often received by the merchant in an already activated state (or may be activated in bulk by the merchant) subjecting them to theft and potentially unauthorized use. Finally, gift cards are essentially bearer cards and provide no security to determine whether the person utilizing the card is authorized to deplete the funds associated with the card.

Prepaid cards are often employed for use in conjunction with telephone services. These prepaid cards are offered either by telephone companies or companies which purchase and resell connection time from telephone companies or other intermediaries. Such prepaid telephone cards are generally available for purchase through merchants including, convenience stores, bodegas and many other retail locations. Prepaid telephone cards are available for purchase in specific, predetermined interval or monetary amounts that correspond to telephone usage time (e.g., “5 minute” or “10 minute” telephone cards). While many versions of the telephone card exist, the most commonly purchased prepaid telephone card is a physical card depicting a ten digit identification number printed on the card. In addition, typically a four digit personal identification number is also printed on the card, generally obscured in some manner.

Use of a prepaid telephone card differs slightly from the use of a gift card as described above. In connection with the current example, the card issuer (i.e., telephone company or reseller) creates and maintains an account associated with the number of minutes associated with each prepaid telephone card. After purchasing a prepaid telephone card, the user generally dials an access telephone number, usually a toll-free number, and enters the ten digit identification number and four digit personal identification number, followed by the telephone number to which the user desires to be connected. These respective card identification and personal identification numbers are typically printed on the card itself and as a result any person having an opportunity to view the card can deplete the minutes associated with the card account.

When a user dials the access telephone number and depletes the minutes associated with the prepaid telephone card, the issuer maintains the account by tracking the number of minutes used and updates the balance on the account accordingly. As with the gift card, when the user depletes all of the units (in many instances, minutes of telephone connection time) associated with a particular prepaid telephone card, the user disposes of the card and purchases a new card to make telephone calls. Alternatively, some telephone cards allow a user to replenish or refresh the telephone card.

The prepaid telephone card system has several disadvantages. First, since a user typically uses a single card to make a limited number of telephone calls, the user must reacquaint him or herself with a new ten digit identification number and four digit personal identification number upon the purchase of each subsequent card. In addition, because the ten digit telephone number and four digit personal identification number are often displayed on the card, any person who has an opportunity to view the card can utilize the telephone account. Similarly, if the card is lost or stolen, any person having access to the card can deplete the minutes associated therewith. Next, similar to the gift cards, a user who has depleted the minutes associated with a particular telephone card generally discards the card and purchases a new card, which requires an additional cost for the merchants. Finally, prepaid telephone cards have no security measure to determine whether the person utilizing the card is authorized to deplete the minutes associated with the card.

Online and Offline Debit systems have become a primary method for consumer transactions. In accordance with the currently available Online debit system, a merchant requires electronic authorization of each transaction. Once the transaction is complete, any debit associated with the card is reflected in the linked account immediately. Generally, the transaction is authorized through the use of a personal identification number (PIN) authentication system. Functionally equivalent to an enhanced automatic teller machine (ATM) card, when making a purchase, a consumer is prompted to enter his or her PIN via a terminal connected to a central processing center over a network. Once received, the PIN is verified by the central processing center and an authorization is transmitted allowing for a real-time debit of the linked account. Overall, the Online Debit System is generally preferred over other available systems because it is arguably more secure by virtue of its authentication system and live status. In addition, the Online Debit System allows for immediate processing without delay and affords a user the ability to withdraw cash from the associated account beyond merely paying for the purchase. The Online system further mimics an ATM card as it also allows most consumers the availability to withdraw an amount in cash above the cost of the purchase.

The Offline Debit System cards are generally issued by major credit card distributor (e.g., Visa™ or MasterCard™ in the United States, Maestro and Solo in the United Kingdom, Interac in Canada, Carte Bleue in France, Eurocheque in Germany, etc.). Users with Offline Debit System cards present a card at the point of sale and authenticate the transaction by providing a signature. Restrictions are Offline Debit System cards are often subjected to a daily limit, and/or a maximum limit equal to the funds contained within the account from which it draws funds. One drawback to the Offline Debit System is the time between purchase and when the transaction appears on a user's account, historically the industry has recognized a two to three day period, however this window is decreasing as a result of system improvements and processing requirements.

Prior art systems for the issuance of Online and Offline debit card programs require several basic steps as depicted in FIG. 1 (PRIOR ART). In addition to the physical plastic debit card (not depicted), the system requires a card user/purchaser, a card issuer, an agent for selling or distributing the card (often a retail merchant), a terminal, and a card processing center. The card issuer (i.e., a financial institution) issues a debit card through a branch of the financial institution, an agent, or a network of authorized agents. In the present scenarios depicted in flow chart 100, a card purchaser interacts with an authorized agent having a networked workstation. In the present example, the networked workstation is located at a merchant (i.e., an authorized agent); however, such a workstation may be located with a branch of the financial institution issuing the card (e.g., a bank branch) or another agent such as a program sponsor. The workstation is capable of performing a myriad of functions including debit card activation, PIN establishment and confirmation, card account loading, and inquiries and related transactions. As currently practiced, an individual employed by merchant, financial institution, etc. inputs information obtained from the card purchaser into the merchant workstation. Such information is generally limited to the card purchaser's name, address, and other basic identifying information. Typically the merchant employee is not charged with substantial verification of the information provided beyond mere confirmation of the existence of the proffered identification, but simply enters and transmits a request via a communications network (such as a proprietary or encrypted shared network) to the processing center. At the processing center, the information related to the debit card, certain transaction rules, and a PIN (either pre-established based on the card number, temporarily assigned by the institution, or in limited instances, user defined) are associated with the transaction. In addition, the processing center submits a request for approval to the issuing bank, notifying the issuing bank of the transaction. Once approved, the processing center returns an approval to the merchant authorizing the issuance of a temporary debit card. The temporary debit card has certain inherent restrictions which are removed once the permanent card is issued and mailed to the card purchaser.

While the advantages of Online and Offline debit cards is clear to one of ordinary skill in the art, the evolution of the issuance of the Online and Offline systems exhibit flaws. First and foremost, security measures are virtually non-existent with present systems. As currently administered, a debit card can be issued to any person as long as the person provides a mere name and related false identity. As a result, in practice the issued debit card can be utilized anonymously by a person in possession of the card and debit cards have recently become known to be a good choice for terrorist activities. Second, the existing systems for issuing debit cards are cumbersome, timely, and expensive. For example, in accordance with existing protocol, an individual applying for a debit card is generally provided a flat plastic card which is temporarily linked to the account established by the individual. After certain processing a new card, typically depicting the individuals name only is sent via postal mail to the user several days after the user applications. It is apparent to one of ordinary skill in the art that such a system results in needless expense as the processing requires human interaction, postal fees, and the preparation and production of two cards. As such, it is readily recognized that it would be advantageous for numerous reasons to provide a card that is immediately issued which avoids the wait and cost typically required to receive a card bearing the name of the user.

In order to overcome the inherent aforementioned disadvantages of existing systems numerous systems and methods exist for issuing and maintaining prepaid cards. For example, in order to attempt to control the inherent theft associated with prepaid cards, U.S. Pat. No. 6,832,720 describes a prepaid debit card with activation control. Specifically, the patent discloses a secured debit card package containing a card having an embedded value and two identification numbers. Rather than employing an integrated circuit, the card within the package contains a card identification number and a magnetic stripe containing an encoded representation of the card identification number. The package is designed in such a way as to conceal one of the identification numbers while revealing the other. The package is presented at a merchant check-out station. At the check-out station, the card is swiped, passing card information through a terminal. The terminal receives the encoded representation of the card identification number and transmits the card identification number to a host computer for processing. The host computer verifies whether the card should be activated for use, (i.e., that the card is genuine and has not been stolen) and activates the personal identification number associated with the debit card so that the purchaser may use the card.

Another apparatus and system for providing prepaid cards is disclosed in U.S. Pat. No. 6,832,720. The system and method as disclosed comprises prepaid cards carrying embedded monetary or unit values (i.e., the purchaser selects the prepaid card having a predetermined denomination as labeled on the specific card). While this type of system overcomes certain flaws of this system described in the aforementioned U.S. Pat. No. 6,832,720, both systems still exhibit numerous disadvantages to the consumer, the issuing institution, and on a broader scale, the national security of a nation. First, and most importantly, no safeguards are in place to verify the identity of the purchaser and that the purchaser is authorized to carry a card of this nature. It is tantamount in the present environment that persons in possession of any financial cards, including debit cards, are not in position to utilize such cards in any manner which is a threat to the national security of any nation. Also, with respect to the present system, the method of providing pre-determined monetary values is restrictive as the purchaser cannot choose the specific value of the prepaid card. Next, in accordance with the disclosed system, the user must reacquaint him or herself with a new ten digit identification number and four digit personal identification number upon the purchase of each subsequent card. In addition, once activated, any person who bears possession of the card and the personal identification number can access the remaining funds associated with the card. As a result, threat of cards of this nature is rampant—clearly, a further threat to the security of a nation. That is, while the disclosed system and method provides for security of the card prior to activation, it does not provide for any security measures once the card has been activated. For example, if the card is lost or stolen, any person having access to the card and knowledge of the four digit personal identification number can use the card. The disclosed system and method does not ensure that the person utilizing the card is authorized to deplete the funds associated with the card. Finally, the disclosed system requires cards to carry an embedded value and as a result such value can not be increased as a result of reloading the card. Therefore, a user who has depleted the funds associated with a particular card discards the card and purchases a new card, requiring additional cost for the issuers.

Another example of existing prepaid card systems is embodied in U.S. Pat. Nos. 6,473,500 and 7,252,226. These related patents disclose a system and method for using a prepaid card which allows the purchaser to specify the value of the card and to reload funds to the card. More specifically, the disclosed system and method allows a user to purchase an inactive card and to activate the card at a terminal (including via interactive voice response service). According to the specification, a user purchases a prepaid card from a point of sale location (i.e., merchant), automated teller machine, card issuer, or designated agent, and then proceeds to activate the card. Activation of the card occurs at a networked terminal which may or may not be located at the site which the card was purchased. Alternatively, activation may be accomplished via telephone by calling an interactive voice response system. Activation requires a multitude of card purchaser inputs. For example, rather than having a pre-designated personal identification number assigned by the issuing entity as described in the above-referenced prior art systems, the purchaser of a debit card in this scenario must specify a personal identification number. The disclosed system and method allows the user to use the prepaid card to purchase goods and/or services from a variety of retailers, withdraw funds from automated teller machines, or request additional funds from the retailer above the cost of goods purchased from the specific retailer.

The system and method described in U.S. Pat. Nos. 6,473,500 and 7,252,226 has several disadvantages. Importantly, the card as described within the disclosed system and method contains limited and arguably ineffective security measures to ensure that the person utilizing the activated card is authorized to deplete the funds on the card. The specification discloses that before authorizing a transaction, the central processor verifies the card number and the personal identification number. However, this does not protect against theft of the card along with theft of the personal identification number. While it is true that the system and method described in U.S. Pat. Nos. 6,473,500 and 7,252,226 provides slightly more security than the systems described above, simply allowing the user to choose the personal identification number does not provide additional security to ensure that the user of the card is authorized to utilize the funds associated therewith. In addition, the system and method disclosed in U.S. Pat. Nos. 6,473,500 and 7,252,226 do not provide for any security with respect to the identity of the user. One of ordinary skill in the art will readily recognize that such a safeguard is limited, especially against terrorist activities plaguing systems of this nature. Considering the contemporaneous environment with respect to global war and terrorism issues, it is a disadvantage of the disclosed system that the system does not perform any verification of the purchaser prior to issuing the prepaid card. A card issued in accordance with the disclosed system can be utilized anonymously by a person who has not been subjected to any verification, making the card a good choice for terrorist activities.

In yet another example of an existing transaction card system and method, U.S. Pat. No. 7,614,549 discloses a system and method for immediate issuance of transaction cards. The system and method disclosed includes providing transaction cards including a storage medium encoding a card number identifying the card to a merchant store for distribution within a store. A user receives a card while inside the merchant store and provides credit application information. The merchant store clerk transmits the credit application information via a terminal and communications link to a remote computer system for evaluation while the user remains inside the merchant store. If the user is approved for credit based on the application information, the transaction card is activated and handed to the user. Once in possession of the card, the card purchaser can utilize the activated card for purchases immediately. Although the specification is directed mainly to utilization of the transaction card as a credit card, the specification discloses that the card can be linked to a master account for use as a debit card.

Several drawbacks exist with respect to the existing system as described by U.S. Pat. No. 7,614,549. Importantly, the card that is immediately issued provides no security measures to ensure that the card is only used by the authorized account-holder—a substantial threat to the security of any nation as previously mentioned. According to the specification, while the user is directed to provide credit information prior to activation of the account, the transaction card is described as bearing no visible marking presenting information concerning the applicant. Therefore, upon subsequent uses, the identity of the user is relatively unknown and no safeguards are in place to confirm that the card user is the same person as the card purchaser (e.g., the card does not provide any security that the bearer is authorized to utilize the funds (or credit) associated with the card). Further, while the patent specification discloses credit application verification, there is no verification with respect to the identity of the purchaser. As described, the card does not bear any features identifying the bearer, making the card an accepted means for utilizing funds anonymously. It is imperative when considering the current political climate to ensure that the purchaser of a transaction card will not utilize the funds associated with the card in an inappropriate manner (including for purposes linked to terrorism). The system and method disclosed in U.S. Pat. No. 7,614,549 does not provide for any security measures to ensure that the purchaser is accountable for the use of the transaction card.

It would, therefore, be advantageous to have a prepaid card that addresses the above-noted problems of existing systems. It would be advantageous to provide a card that is more flexible than the cards typically available today, that allows a cardholder to purchase a card without an issuer-established preset value and to select a PIN that is easily remembered, a card that is preferably reloadable, and that also allows purchases to be made from a wide variety of merchants. It would also be advantageous to provide a card that is individually activated at the point of sale, so that the card would not be able to be used by unscrupulous employees or other individuals who may intercept the card in transit between the card issuer and the point of sale, or when it is displayed at the point of sale. It would also be advantageous to provide a card that is immediately issued to avoid the wait typically required to receive a card bearing the name of the user. It would be advantageous to provide a card that provides additional security measures to ensure that the bearer of the card is authorized to utilize the funds associated with the card, where the security measures are readily apparent by a merchant at the point-of-sale. It would further be advantageous to provide a card that requires a background check on the purchaser to ensure that the purchaser is not linked to any terrorist activities.

### SUMMARY OF THE INVENTION

The present invention provides an apparatus and method for immediate issuance of a prepaid card having improved security measures ensuring use of the prepaid card by the authorized user.

In the various embodiments disclosed herein it is a primary object of the present invention to provide a prepaid card bearing at least the name and photograph associated with the authorized user of the card to eliminate the potential use of the card by anyone other than the authorized user.

It is a further object of the present invention to provide a prepaid card with the improved security features as described above via a method that allows immediate issuance, thereby providing the user with a secure, prepaid debit card without waiting to receive a card via United States Postal Service.

It is yet a further object of the present invention to provide a system and method that greatly reduces the costs associated with issuing prepaid cards by eliminating the need for a second card to be issued via United States Postal Service subsequent to a temporary card being issued at the point-of-sale.

It is a further object of the present invention to provide a system and method for immediately issuing a prepaid card that verifies the identity of the potential cardholder in compliance with Customer Identification Program guidelines.

It is a further object of the present invention to provide a system and method for immediately issuing a prepaid card that verifies the identity of the potential cardholder using documentary verification and non-documentary verification in compliance with Section 326 of the USA Patriot Act.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment and alternate embodiments set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1 (PRIOR ART) shows a diagram of the summarized components of a system for applying for a debit card and approval process for receipt of a debit card in accordance with general prior art systems.

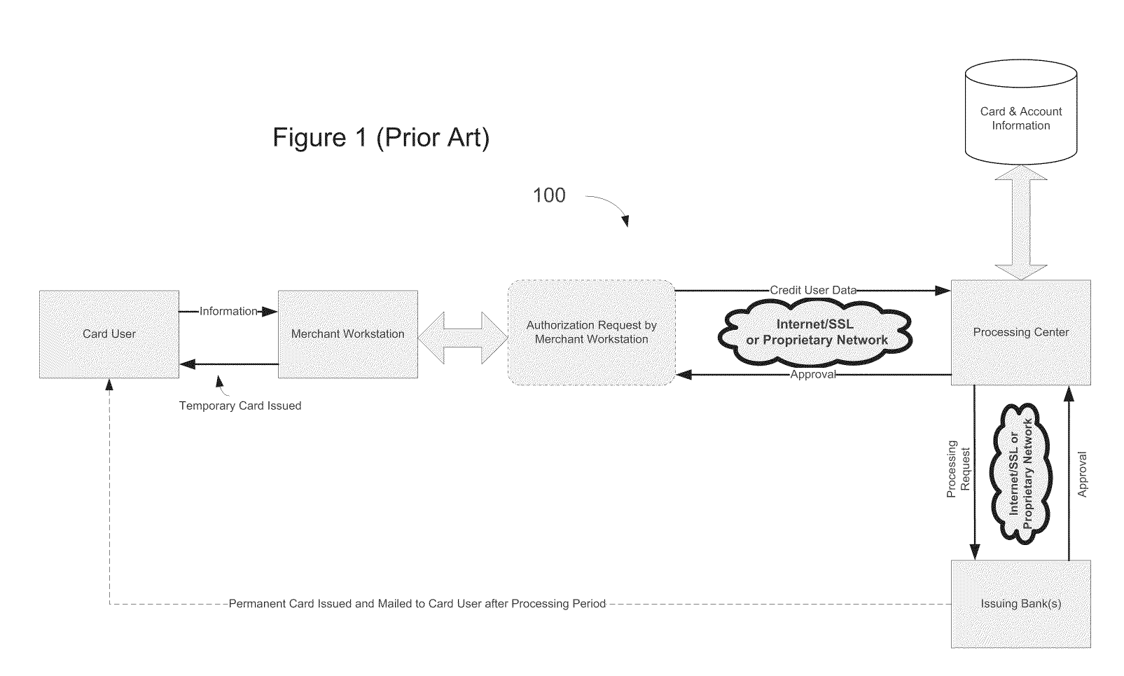

FIG. 2 is a diagram of the point-of-sale station process implemented by the card registration, cardholder identification, card verifications, and card production system in accordance with the preferred embodiment of the present invention.

FIG. 3 is a diagram of the instant verification system implemented by the card registration, cardholder identification, card verifications, and card production system in accordance with the preferred embodiment of the present invention.

FIG. 4 is a diagram of the interaction of the processing servers with point-of-sale systems implemented by the card registration, cardholder identification, card verifications, and card production system in accordance with the preferred embodiment of the present invention.

FIG. 5 is a flow diagram showing the prepaid card registration process portion of the card registration, cardholder identification, card verifications, and card production system in accordance with the preferred embodiment of the present invention.

FIG. 6 is a flow diagram showing the activation process for a registered card implemented by the card registration, cardholder identification, card verifications, and card production system in accordance with the preferred embodiment of the present invention.

FIG. 7 is a diagram of the immediate prepaid debit card registration and printing system in accordance with the preferred embodiment of the present invention.

FIG. 8 is a diagram of the activation system for a registered card implemented by the card registration, cardholder identification, card verifications, and card production system in accordance with the preferred embodiment of the present invention.

### DETAILED DESCRIPTION OF THE PREFERRED EMBODIMENT

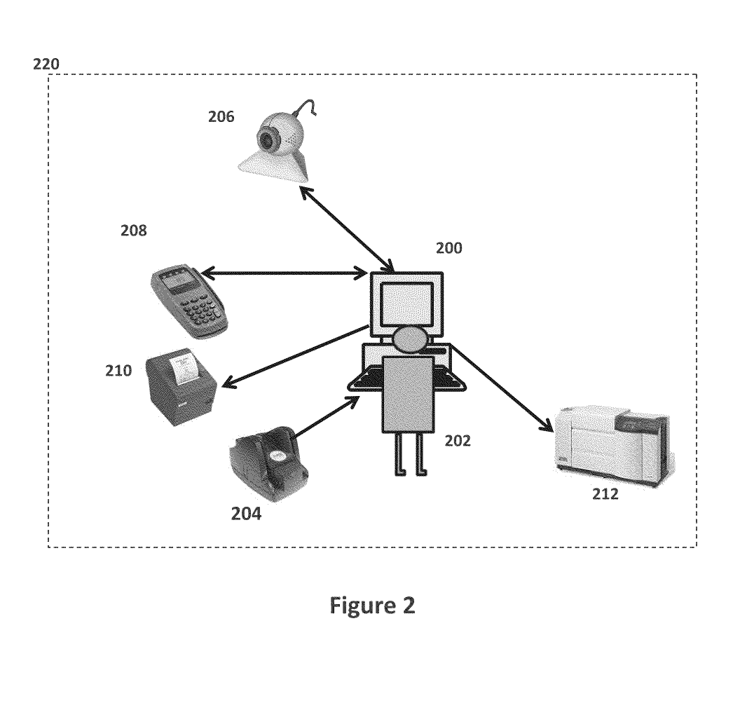

Referring first to FIG. 2, depicted is an illustration of point-of-sale station portion, including a multitude of input devices, of the system in accordance with the preferred embodiment of the present invention. Specifically, the present invention is directed to a system and method for immediate issuance of a prepaid card having improved security measures to ensure authorized use of the funds associated with the card. Point-of-sale station 220 includes workstation 200 for use by operator 202. As depicted, workstation 200 is coupled to a series of input devices including scanner 204, digital camera 206, and PIN pad 208. Further connections are provided for output devices such as receipt printer 210 and card printer 212.

The capabilities of point-of-sale workstation 200 allows an operator 202 to receive and record information provided by a potential cardholder or card purchaser. According to the preferred embodiment of the present invention, workstation 200 exhibits the general structure of a common computing device or “dumb” terminal, having one or more processors and integral or linked memory mean(s) to compute and store information. In addition, as depicted, workstation 200 comprises various input and output devices, including scanner 204, digital camera 206, PIN pad 208, receipt printer 210 and card printer 212 as well as other input/output devices commonly known in the art such as keyboard, display, and pointing devices (e.g., mouse). While not depicted, one of ordinary skill in the art will readily recognize that various additional input and/or devices may be utilized with the present system without departing from the spirit of the invention. For example, input devices may further include a myriad of biometric-capable devices for uniquely recognized a humans based on certain intrinsic characteristics, such as a face recognition device, a fingerprint input device, voice recording or voice rhythmic device, body scanner, or other known or similar device. As is readily understood in the art, peripherals such as scanner 204, digital camera 206, PIN-pad 208, receipt printer 210, card printer 212, and others may be coupled to workstation 200 via a variety of means, including any known of to be developed wired or wireless connection.

In accordance with the preferred embodiment of the present invention, the system components (i.e., workstation 200 and all peripherals) are co-located at a particular point-of-sale. However, as will be readily understood by a person of ordinary skill in the art, workstation 200 can be located off-premises so long as the input and output devices are located at the point-of-sale, or readily accessible by a merchant or other entity at the point-of-sale. That is, it is preferred in the present invention that processing and storage of the information collected at the point-of-sale can occur at a location other than the point-of-sale; however, it can be easily recognized by one of ordinary skill in the art that the inherent benefits of the present can also be achieved by an integrated system residing at a single location.

By way of example, in order for a potential cardholder or card purchaser to obtain a desired card, the potential cardholder or card purchaser must interact with human operator 202. Since security is of paramount importance in the present embodiment of the present invention, it is desirable in the present invention for operator 202 to be human; however, it is contemplated that an alternate embodiment of the present invention allows for the integration of systems and apparatus for the completion of the specified tasks by non-human systems. Specifically, interactive voice recognition systems and other input devices may be employed to request, record, transmit, and store the requisite information proffered by a potential cardholder. Further, certain aforementioned biometric systems can be utilized to confirm the inputted information.

Continuing with the preferred embodiment, human operator 202 receives information from a potential cardholder and inputs the provided information into workstation 200. The potential cardholder supplies information relating to a prepaid debit card application including identification information, such as the potential cardholder's driver's license, U.S. Social Security card, U.S. Social Security number, passport, credit card, or other similar identification object. Scanner 204 is utilized to capture a digital image of the identification information provided or in certain instances a card-reading device may be employed. Such a card-reading device can exhibit the ability to interact with a radio frequency identification device (“RFID”), a magnetic device, a device for emitting ultraviolet and recording the resulting images such as common holograms currently utilized on various driver licenses, etc. As a secondary safeguard to further authenticate the information object supplied by the potential cardholder, the digital image is transmitted from scanner 204 to workstation 200 and operator 202 is prompted to further supplement the scanned information relating to the digital image, including type of identification provided and details associated with the identification (e.g., driver's license number, expiry date, existence of hologram, etc.). Workstation 200 verifies the information entered by operator 202 with the digital image of the identification provided by scanner 204, either based on resonant stored data or date obtained via the wired or wireless link.

Operator 202 further solicits a photograph of the potential cardholder using digital camera 206 to capture a digital image of the potential cardholder. The digital camera is coupled to workstation 200. Workstation 200 continues to populate the record of the potential cardholder by linking the captured image to the other data inputted related to the potential cardholder. In the present embodiment of the invention, digital camera 206 functions to merely record the image of the potential cardholder; however, it is contemplated in the present invention for alternate embodiments to employ cameras capable of advanced functions such a facial recognition, iris recognition, or the like.

Operator 202 solicits personal identification number (“PIN”) information from the potential cardholder using PIN-pad 208. Once PIN-pad sequence is initiated by operator 202 or automatically by workstation 200 as a result of a defined sequence, workstation 200 provides a series of inquiries to potential cardholder. The potential cardholder is prompted to first enter a personal identification number using the PIN-pad 208, then to enter the personal identification number a second time to verify the accuracy of the submission. Workstation 200 receives the two entered numbers and compares the input to verify that the number has been entered identically in repetition. Workstation 200 links the information received from PIN-pad 208 with the other populated information associated with the potential cardholder.

in accordance with the preferred embodiment of the present invention, further verification information can be requested by workstation 200 via PIN-pad 208. For example, PIN-pad 208 is capable of allowing a potential cardholder to provide numerical verification information to verify the authenticity of potential cardholder based on previous data entered or data maintained by secondary sources, such as government security database, databases maintained by financial institutions, databases maintained by other domestic and international federal, state, and local authorities, etc. For example, as part of the immediate verification and issuance process associated with the present invention, PIN-pad 208 is capable of displaying questions, the responses to which are calculated to confirm and authenticate the identity of the potential cardholder (i.e., house number of a previous address, current age in years, etc.).

Receipt printer 210 is coupled to workstation 200. Receipt printer 210 is capable of various functions, including, but not limited to, printing receipts for the potential cardholder to Verify account information associated with the card, such as balance. In addition, upon approval of the potential cardholder (discussed below) operator 202 may initiate receipt printer 210 to provide a receipt displaying the account information and provide the receipt to the potential cardholder. Alternatively, a predetermined sequence may be established allowing receipt printer 210 to automatically print said record or copies thereof for potential cardholder inspection.

Card printer 212 is also coupled to workstation 200 for the printing of prepaid cards in various forms. Upon approval of a potential cardholder (discussed below) operator 202 may initiate a request for a prepaid card to be printed. Workstation 200 transmits information, including identifying indicia such as the name of the potential cardholder, digital image representing a photograph of the potential cardholder, etc. to card printer 212. In response to the request, card printer 212 generates a prepaid card bearing the information received from workstation 200. [FURTHER INFORMATION REQUESTED RELATED TO PRINTED CARD—bank indicia?, type of card?, raised numbers?, foreseeable that future systems may include RFID or like devices which can be activated by present system, etc.] Since the prepaid card bearing information identifying the authorized user printed by card printer 212 is valid pending activation and is presented to potential cardholder in final form, no temporary card is required. In addition, since the verification is complete, including issuing bank authorization, interaction with issuing bank is complete and issuing bank is not required to prepare and transmit a replacement or final card to potential cardholder.

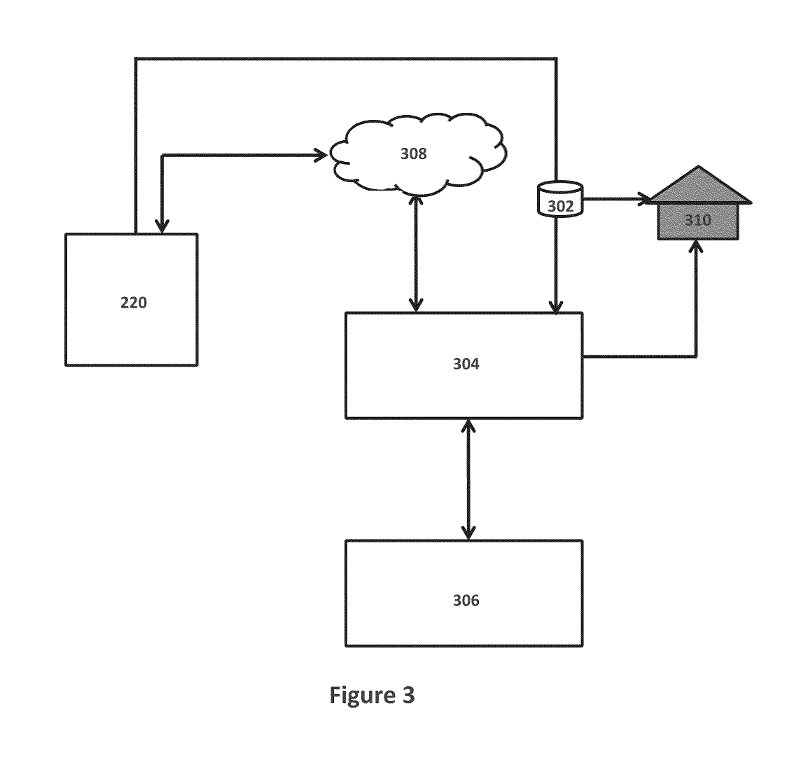

Referring now to FIG. 3, depicted is the instant verification system in accordance with the preferred embodiment of the present invention. Point-of-sale system 220 is coupled to offsite memory 302, processing servers 304, and payment systems processor 306. Offsite memory 302 is further coupled to issuing bank 310. In accordance with the preferred embodiment of the present invention, information is transferred from point-of-sale system 220 (as examined in FIG. 2) to offsite memory 302 via file transfer protocol to processing servers 304 via secure connection over the internet 308. As will be readily understood in the art, different methods of transmission exhibiting various degrees and methods of encryption can be utilized to transmit the information without departing from the scope of the invention.

Still referring to FIG. 3, shown is the transmission of identification images from workstation 220 to offsite memory 302. Specifically, digital identification images, including images comprising identification documents, photographs, etc. compiled by point-of-sale system 220 are transmitted to offsite memory 302 for storage and transmission to issuing bank 310. In accordance with the preferred embodiment of the present invention, transmission from offsite memory 302 to issuing bank 310 occurs as a batch transaction. It will be readily recognized that the presently disclosed system provides immediate authorization and issuance of prepaid cards for potential cardholders, and as a result there is no need to incur additional expense by transmitting such information upon receipt at offsite memory 302. However, it will be readily understood by one of ordinary skill in the art that immediate transmission of information from offsite memory 302 to issuing bank 310 does not depart from the scope of the present invention.

Further depicted in FIG. 3 is the transmission of application information to processing servers 304 for validation and editing of the transaction. Processing servers 304 comprise a proprietary system capable of such services as supporting card registration, account monetary loads, card imprinting, cardholder information processing, SMS text messaging enrollment, balance inquiry, account activation, PIN selection, PIN confirmation, etc. Processing servers 304 receive application information and identification image information from a plurality of point-of-sale systems 220 in order to provide a completely validated query to payment systems processor 306.

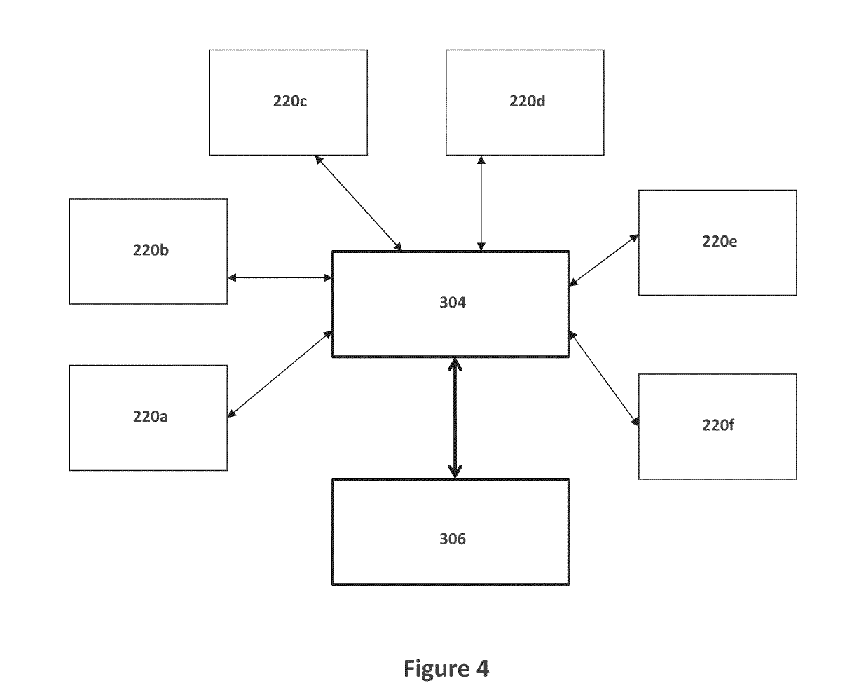

Referring now to FIG. 4, shown is processing servers 304 coupled to a plurality point-of-sale systems 220a, 220b, 220c, etc. The preferred embodiment of the present invention utilizes processing servers in a single location to compile, store and process applications for potential cardholders initiated at a plurality of point-of-sale systems. However, it will be readily appreciated by one of ordinary skill in the art that multiple processing servers in a plurality of locations, including servers capable of providing redundancy of operations or servers designated for unique functions can be utilized without departing from the scope of the invention.

Referring again to FIG. 4, payment systems processor 306 determines, based on the input received at workstation determines the veracity of the input and ultimately determines whether to authorize and qualify the potential cardholder for receipt of a prepaid card. Based on this qualification process, payment systems processor 306 transmits a response (e.g., authorization or refusal) to processing servers 304. In turn, processing servers 304 transmit the response to point-of-sale system 220. In addition, information indicating the updated status with respect to authorization of a potential cardholder is transmitted to issuing bank 310 from processing servers 304, thereby allowing issuing bank 310 to properly track the record of potential cardholder.

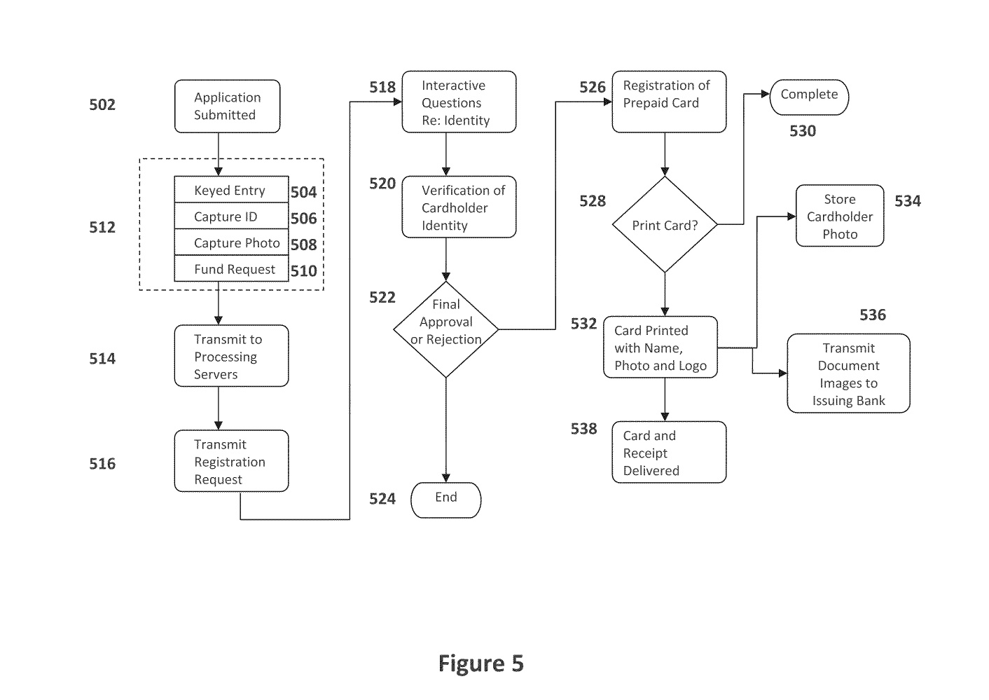

Referring now to FIG. 5, depicted is a flow diagram showing the prepaid card registration process of the preferred embodiment of the present invention. As indicated in box 502, a potential cardholder submits an application for a prepaid card, including providing personal information such as date of birth, U.S. Social Security Number, primary and/or secondary place of residence, etc. The personal information provided by the potential cardholder should be sufficient to comply with the “Know-Your-Customer” due diligence regulations and the requirements associated with the Sarbanes-Oxley Act of 2002, Office of Foreign Assets Control (“OFAC”) Specially Designated Nationals (“SDN”) list, or other anti-money laundering statutes established in the United States or internationally which are typically designed to disrupt the flow of monetary funds to terrorists or terrorist organizations and in many instances white-collar fraud transactions. The information provided by the potential cardholder should also be sufficient to allow the issuing bank to communicate with the potential cardholder regarding the account, once established. The application information can be provided via paper application and scanned therein, but in one embodiment of the present invention, the information can be provided to an operator orally. Once the application is completed, the application is printed and displayed in electronic format to the potential cardholder or in traditional paper form and verified via signature by the proposed cardholder.

All of the information required to request authorization for the potential cardholder, as previously defined, is compiled within the system of the present invention as shown in box 512. Whether proffered orally or via paper application, the information provided by the potential cardholder is entered into the system via a terminal located at the point-of-sale as depicted in box 504. The potential cardholder provides an acceptable form of identification (e.g., passport, driver's license, state identification card, etc.), a digital image of which is captured via scanner as shown in box 506 and entered into the system. In addition, a digital image comprising a photograph of the potential cardholder is captured using a digital camera as depicted in box 508 and entered into the system. As part of the initial process, the potential cardholder indicates the dollar amount which he or she would like to be accessible by the prepaid card, as shown in box 510. All of the information collected by the system in box 512 is linked to an account to be established relating to the potential cardholder pending authorization.

Once the information is collected in box 512 and linked as part of a file associated with a potential cardholder, the file is transmitted along with a registration request to processing servers in box 514. Once compiled and verified on the processing servers, the information and registration request are forwarded to a payment systems processor for establishing the account and initial balance in box 516. If the information entered is a potential violation of the “Know-Your-Customer” due diligence regulations and the requirements associated with the Sarbanes-Oxley Act of 2002, the system is capable of rejecting and flagging the transaction. In certain instances, a notification can be transmitted to local authorities in a discreet manner and a Suspicious Activity Report (“SAR”) can be filed.

The payments processor analyzes the information associated with the potential cardholder to determine whether to authorize the request for a prepaid card in the amount requested. The payments processor analyzes one or more of the potential cardholder's name, address, telephone number, identification information (e.g., driver's license, passport, state identification), photograph, and amount of funds request. This analysis to confirm the identity of the potential cardholder occurs in real-time. As part of the analysis, the payments system processor can transmit an inquiry transaction back to the system to obtain interactive confirmation from the cardholder of additional personal information, as shown in box 518.

When the payments system processor transmits an inquiry, the potential cardholder is prompted to verify information via the PIN-pad located at the point-of-sale. Specifically, the potential cardholder is asked for information distinct from the information provided by the potential cardholder during the application process in an attempt to verify the identity of the potential cardholder. For example, the potential cardholder can be requested to identify such information as a house number of a previous address, his or her current age in years, etc. in an attempt to further verify the identity of the potential cardholder. The potential cardholder's responses are submitted to the payment systems processor for verification as depicted in box 520.

Upon receipt of the potential cardholder's responses, the payment systems processor compares the responses to the information contained within the databases maintained in accordance with the Customer Identification Program established by Section 326 of the USA Patriot Act. Specifically, the payment systems processor maintains records of the information used to verify a person's identity, including name, address, and other identifying information and consults lists of known or suspected terrorists or terrorist organizations provided to the financial institution by any government agency to determine whether a person seeking to open an account appears on any such list.

If registration of the potential cardholder is denied, the process is terminated as shown in box 524 and the operator at the terminal located at the point-of-sale is notified. If registration of the potential cardholder is authorized, the system will provide a registration confirmation to the terminal at the point-of-sale and registration of the card is accomplished as shown in box 526.

Upon receipt of a registration confirmation, the terminal located at the point-of-sale is provided with a prompt whether to print a prepaid card as depicted in box 528. If a request is made for the card to not be printed (e.g., the registration was Made to correct misinformation associated with an existing account) the card issuance process is completed as shown in box. If the card is to be printed, the registered card is placed in the card printer located at the point-of-sale. The card is then printed, including a display of the name of the cardholder and a display of the digital photograph established at the point of sale by the cardholder, as shown in box 532. In addition, a card logo is provided as well and in alternate embodiment an RFID is activated.

After the card is printed, the digital photograph information associated with the registered cardholder is uploaded to a server and transmitted to a card production system for storage as shown in box 534. The digital photographs can be stored immediately in the card production system or batched for nightly transmission or other prescribed period for data transmission. Similarly, the digital images comprising cardholder identification documents collected in box 506 are uploaded to a server and transmitted to the issuing bank as depicted in box 536.

The cardholder is then provided with the newly printed card bearing the authorized cardholder's name and photograph, and a receipt showing the current balance on the card as depicted in box 538. The permanent card is now registered and valid, but must be activated prior to use.

It should be understood that the method of the present invention described above utilizes documentary verification and non-documentary verification as required by Section 326 of the USA Patriot Act. Specifically, the application information collected in box 506 (e.g., driver's license information, passport information, state identification information, etc.) comprises documentary verification as confirmed by the payment systems processor in box 516. The application information collected in box 502, in addition to the responses given by the potential cardholder to the interactive questions provided in box 518, comprise non-documentary verification. The system of the present invention therefore allows immediate authorization and issuance of a permanent prepaid card while complying with the requirements of Section 326 of the USA Patriot Act. As a result, a valid and permanent card is provided to the potential cardholder rather than a temporary card which is commonplace in the art.

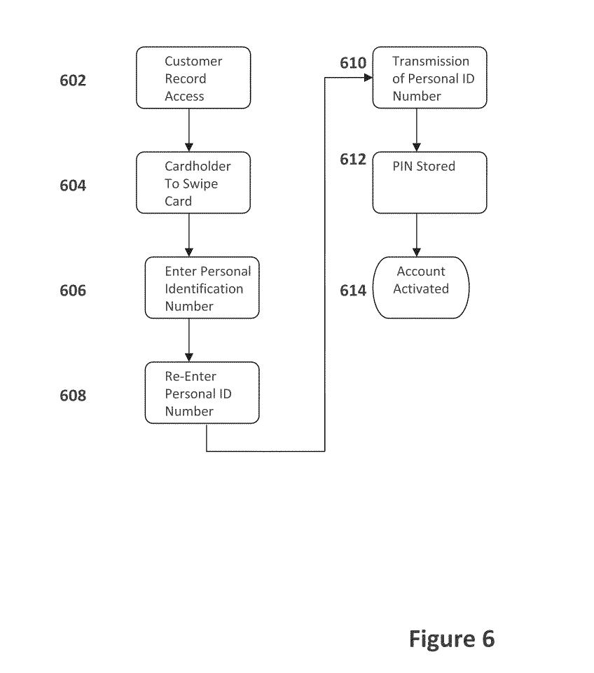

Referring now to FIG. 6, shown is the activation process of a registered card in accordance with the preferred embodiment of the present invention. Once a card is registered using the process documented in FIG. 5, the cardholder must activate the account associated with the card prior to using the card. The activation process can occur automatically following the registration of a card, or can occur as a discrete transaction initiated by the terminal at the point-of-sale. The cardholder has already been verified and as a result the activation of a prepaid card can also occur at a point-of-sale location separate from the point-of-sale location where the card was purchased, at an existing kiosk or authorized automated teller machine, via telephone using an interactive voice response system, or other means known in the art for activating prepaid cards.

To activate a prepaid card, the customer record containing the registered card information is accessed as shown in box 602 and the system sends a signal to the PIN-pad terminal device. As depicted in box 604, the cardholder is directed to swipe the registered card and then to enter a four digit personal identification number (or other predetermined alphanumeric entry comprising a plurality of characters) into the PIN-pad device for security purposes as shown in box 606. After entry of the four digit personal identification number, the cardholder is requested to enter the identical four digit personal identification number into the PIN-pad for verification in box 608. Once confirmed, the point-of-sale terminal transmits the cardholder's verified personal identification number to the processing servers as shown in box 610.

Upon receipt by the processing servers, the personal identification number is encrypted and stored with the account information as shown in box 612. The account is now fully active and ready for use as depicted in box 614.

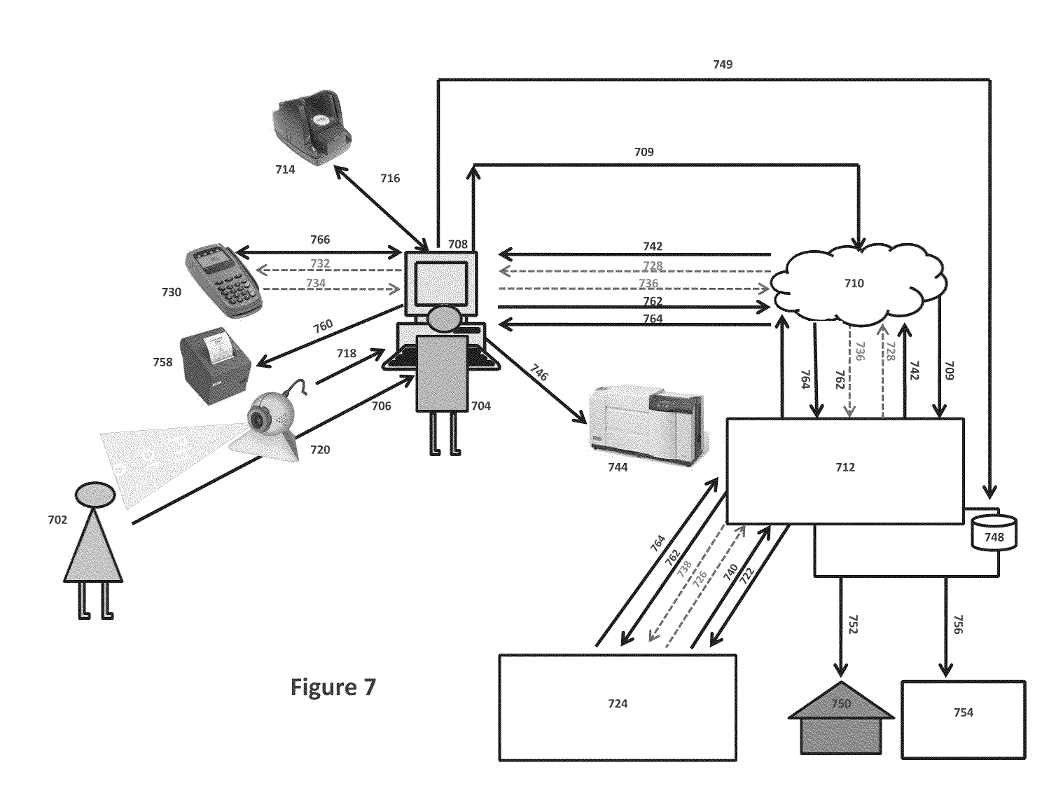

Referring now to FIG. 7, shown are the hardware and process associated with the system and method for card registration, cardholder identification and card production in accordance with the preferred embodiment of the present invention. Potential cardholder 702 provides application information to workstation operator 704 as depicted in step 706. The application information provided in step 706 in accordance with the scope of the present invention includes information necessary to verify the details associated with the proposed debit card account as well as the identity of proposed cardholder 702. Such application information can include, but are not limited to, one or more of the following identity information: name, address, contact telephone number, contact mobile telephone number, electronic mail address, sex, birthday, social security number, identification type, identification details, initial load amount, enrollment information in SMS text account information plan, and balance inquiries. It is important to note that the application information provided 706 by potential cardholder 702 is sufficient to, at a minimum, comply with the Know Your Customer and Sarbanes-Oxley provisions, as well as to allow communication with potential cardholder 702 regarding the account, if necessary. The application information provided 706 by potential cardholder 702 can be entered manually into workstation terminal 708 by workstation operator 704. Alternatively, workstation terminal 708 can receive the information via scan or entry by potential cardholder 702 directly through a proprietary software-driven device.

Application information collected in step 706 is transmitted to debit card module 712 via transmission network 710 in step 709. In accordance with the preferred embodiment of the present invention, transmission network 710 comprises a secured connection via the internet. As will be readily appreciated by one of ordinary skill in the art, any secure transmission network can be utilized without departing from the scope of the presently disclosed invention, including a secure direct connection. Debit card module 712 comprises a series of servers capable of validating the source of the data transmission (e.g., verification of workstation operator 704). Debit card module 712 supports card registration, account monetary loads and debits, card imprinting, cardholder information processing, SMS text message enrollment, balance inquiry, account activation and PIN selection.

In furtherance of obtaining a prepaid debit card, potential cardholder 702 provides documentary identification information via scanner 714. Workstation operator 704 collects digital image information from scanner 714 in step 716 and manually enters information relating to the type and details of the documentary identification information into workstation terminal 708. In step 718, workstation operator 704 also collects digital image information in the form of a photograph of potential cardholder using digital camera 720. The digital image information collected in steps 716 and 718 is stored within the system and associated with the record created in debit card module 712 relating to potential cardholder 702.

Once all of the information is collected to create a record associated with potential cardholder 702, a registration request is sent in step 722 from debit card module 712 to payment systems processor 724 to establish an account and establish an initial balance. Payment systems processor 724 performs a verification of the identity of potential cardholder 702 in real time. As part of the real time verification, payment systems processor transmits an interactive inquiry in step 726 to obtain additional information to verify the identity of potential cardholder 702. Debit card module 712 transmits the interactive inquiry to workstation terminal 708 via transmission network 710 in step 728, where the interactive inquiry forwarded to PIN pad 730 in step 732 and converted to text requesting an immediate response from potential cardholder 702. The interactive inquiry generally comprises a question to which a short answer can be utilized to authenticate the identity of potential cardholder 702. By way of example, the interactive inquiry can request information relating to a potential cardholder's previous address, existing financial accounts, current age, or other personal inquiry (i.e., a question of a personal nature, the answer to which is generally known only by the potential cardholder 702).

Potential cardholder 702 enters a response to the interactive inquiry displayed on PIN pad 730. The response to the interactive inquiry displayed on PIN pad 730 is transmitted to workstation terminal 708 in step 734 and recorded. Workstation terminal 708 transmits the response to the interactive inquiry to debit card module 712 via transmission network 710 in step 736. Debit card module 712 records the responses in the record associated with potential cardholder 702. The responses to the interactive inquiry are forwarded by debit card module 712 to payment systems processor 724 in step 738 for comparison to the known information regarding potential cardholder 702 contained within the records therein.

As part of the verification process, payment systems processor 724 compares the verified information relating to potential cardholder 702 to determine whether the information matches a list of individuals that are not authorized to receive prepaid debit cards. As previously mentioned, Section 326 of the USA Patriot Act requires banks and financial institutions to check the identity of new accountholders to determine whether there is any link between the proposed accountholder and such illegal acts as terrorism, money laundering, etc. Payment systems processor 724, prior to issuing a registration confirmation, accesses a database to determine whether potential cardholder 702 is an individual linked to any of the various illegal acts that would prevent him or her from obtaining a prepaid debit card.

Payment systems processor 724 compares the response to the interactive inquiry with known information and communicates either confirmation of valid responses or match failures in step 740. A match failure results in termination of the registration request. If the response to the interactive inquiry is confirmed as a valid response, the registration is confirmed and registration confirmation is transmitted to workstation terminal 708 via transmission network 710 in step 742. Debit card module 712 records registration of an account associated with potential cardholder 702. When the registration confirmation is received by workstation terminal 708, workstation operator 704 is permitted to immediately issue an authorized prepaid debit card.

Upon receipt of a registration confirmation, workstation terminal 708 displays a prompt to inquire whether to print an authorized secure prepaid debit card. If potential cardholder 702 does not requite a card to be printed, (e.g., the registration process was executed as a result of an inquiry to correct misinformation associated with an existing card account) the registration process ends. If potential cardholder 702 desires a card to be printed, workstation operator 704 places an unassigned prepaid debit card in card printer 744 and directs workstation terminal 708 to transmit information relating to the secure prepaid debit card to card printer 744 in step 746. Specifically, workstation terminal 708 transmits security information to be printed on the prepaid debit card that will ensure that potential cardholder 702 can be identified as the sole person authorized to utilize the funds associated with the prepaid debit card. Such information can include, but is not limited to, one or more of the following identification indicia: name, address, telephone number, account number, photograph, or encoded confirmation number. Such information allows a teller authorized to accept the prepaid debit card as payment for a transaction to verify the identity of the authorized user and confirm that the presenter of the card is indeed authorized to deplete the funds associated with the card. Card printer 744 prints the identification information on the unassigned prepaid debit card. The result is immediate issuance of a prepaid debit card displaying security measures (e.g., authorized cardholder name and photograph) to ensure that the funds are utilized solely by potential cardholder 702.

Following the card registration process, the digital information collected in steps 716 and 718 are transmitted to master server 748 for storage in step 749. In accordance with the preferred embodiment, this information is transferred via encrypted file transfer protocol but can be transmitted using any secure transmission network without departing from the scope of the present invention. Master server 748 transmits the digital documentary evidence information collected in step 716 to issuing bank 750 in step 752. Master server 748 also transmits the digital photograph information collected in step 718 to card production system 754 in step 756. In accordance with the preferred embodiment of the present invention, the transmission of digital images comprising documentary evidence to issuing bank 750 in step 752 and the transmission of digital images comprising photographs to card production system 754 in step 756 occur as batch transmissions on a nightly basis. As will be readily understood by one of ordinary skill in the art, for cost and security reasons, the transmissions embodied by steps 752 and 756 can occur in real time or periodically at any interval without departing from the scope of the present invention.

Upon registration of a prepaid debit card, workstation terminal 708 directs receipt printer 758 to print a receipt reflecting the account information associated with the newly issued card, including transmission of balance information from workstation terminal 708 to receipt printer 758 in step 760. To retrieve balance information, workstation 708 transmits a balance inquiry request to payment systems processor 724 as shown in step 762, and a response is transmitted to workstation terminal 708 as depicted in step 764. Workstation operator 702 provides the printed and registered prepaid debit card to potential cardholder 702 along with the receipt printed at receipt printer 758. Potential cardholder is then in possession of a registered prepaid debit card, which can be utilized immediately upon activation thereof, shown as step 766.

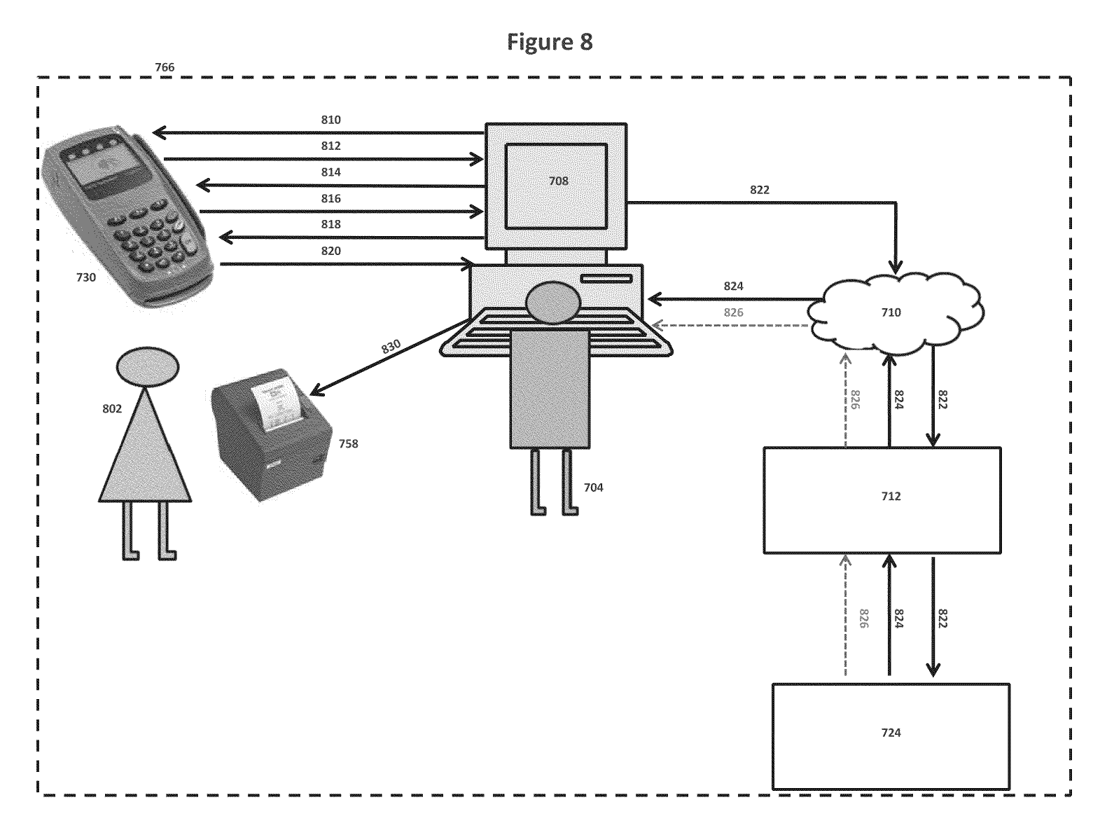

Referring now to FIG. 8, shown is an expanded diagram of step 766 depicting the card activation and personal identification selection process of the present invention. The card activation process can be initiated automatically following registration of a new account, or at a later time should cardholder 802 produce a registered and inactive prepaid debit card. If cardholder 802 has not yet been verified by workstation operator 704, identification of cardholder can be easily accomplished via visual inspection of the name and photograph displayed on the card and verification of same against identification provided by cardholder 802.

Workstation operator 704 utilizes workstation terminal 708 to initiate the activation process and prompts cardholder 802 to swipe the magnetic stripe on the inactive prepaid debit card using PIN pad 730 as depicted in step 810. PIN pad 730 collects information from the magnetic stripe and transmits the information to workstation terminal 708 in step 812. Workstation terminal prompts cardholder 802 to enter a personal identification number using PIN pad 730 in step 814. PIN pad 730 encrypts the information and transmits the personal identification number selected by cardholder 802 to workstation terminal 708 in step 816. Upon receipt of the information provided, workstation terminal 708 prompts cardholder 802 to enter the personal identification number a second time in step 818. Again the personal identification number entered by cardholder 802 is encrypted and transmitted to workstation 708 as depicted in step 820.

Upon receipt of the information from PIN pad 730 in steps 812, 816 and 820, workstation terminal 708 encrypts the information and transmits an activation request along with the information to payment systems processor 724 in real time as depicted in step 822. Payment systems processor 724 verifies that there are no holds on the account (e.g., that the card has not been reported lost or stolen) and that the two personal identification numbers entered by cardholder in steps 816 and 820 match. If the verification is positive and the personal identification numbers match, activation confirmation is sent from payment systems processor 724 to workstation 708 as shown in step 824. Activation is complete and information confirming the activated account and balance associated with the account is transmitted to receipt printer 758 in step 830. If payment systems processor 724 determines that the account associated with the card is not suitable for activation, or if the personal identification numbers entered by cardholder 802 do not match, payment systems processor 724 transmits a signal signifying activation failure to workstation terminal 708 as depicted in step 826.

From the foregoing description of the embodiments, which embodiments have been set forth in considerable detail for the purpose of making a complete disclosure of the present invention, it can be seen that the present invention comprises a system and method for immediate issuance of a prepaid card having increased security measures. It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

What is claimed is:

1) A method for issuance of a prepaid debit card having improved security measures to a potential cardholder, said method comprising:
obtaining identification indicia from said potential cardholder at a point of sale;
capturing and storing a digital photograph of said potential cardholder;
verifying the identity of said potential cardholder by analyzing said identification indicia in real time; and
printing said prepaid debit card at said point of sale, wherein said printed prepaid debit card displays said identification indicia.

2) A method for immediate issuance of a prepaid debit card according to claim 1, wherein said step of obtaining identification indicia further includes capturing a digital image of documentary evidence provided by said potential cardholder.

3) A method for immediate issuance of a prepaid debit card according to claim 1, wherein said step of verifying the identity of said potential cardholder further includes analysis to determine whether said potential cardholder is eligible to obtain a prepaid debit card in accordance with Section 326 of the USA Patriot Act.

4) A method for immediate issuance of a prepaid debit card according to claim 1, further comprising the step of:
activating said prepaid debit card.

5) A method for immediate issuance of a prepaid debit card according to claim 4, wherein said step of activating said prepaid debit card comprises the selection and verification of a personal identification number.

6) A system for issuance of a prepaid debit card having improved security measures to a potential cardholder, said system comprising:
terminal for receiving information relating to said potential cardholder;
first digital imaging device coupled to said terminal for capturing a digital image of documentary evidence relating to said potential cardholder;
second digital imaging device coupled to said terminal for capturing a photograph of said potential cardholder;
processor coupled to said terminal for analyzing said information relating to said potential cardholder in real time;
memory coupled to said terminal for storing said information, digital image and photograph of said potential cardholder; and
card printer coupled to said terminal for printing a prepaid debit card displaying said photograph and at least a portion of said information.

7) A system for issuance of a prepaid debit card having improved security measures to a potential cardholder according to claim 6, further comprising a database wherein said processor analyzing said information relating to said potential cardholder accesses said database in Order to determine whether said cardholder is eligible to receive a prepaid debit card.

8) A system for issuance of a prepaid debit card having improved security measures to a potential cardholder according to claim 7, wherein said determination whether said cardholder is eligible to receive a prepaid debit card complies with the obligations contained in Section 326 of the USA Patriot Act.

9) A system for issuance of a prepaid debit card having improved security measures to a potential cardholder according to claim 6, wherein said first digital imaging device comprises a scanner.

10) A system for issuance of a prepaid debit card having improved security measures to a potential cardholder according to claim 6, wherein said second digital imaging device comprises a digital camera.

11) A method for issuance of a prepaid debit card having improved security measures to a potential cardholder, said method comprising:
obtaining identification indicia from said potential cardholder at a point of sale in the form of a printed application;
capturing a digital image of documentary evidence relating to said potential cardholder at said point of sale;
capturing a digital photograph of said potential cardholder at said point of sale;
transmitting said identification indicia to a processor for real time verification of the identity of said potential cardholder;
storing said digital image and said digital photograph;
receiving an authorization signal at said point of sale from said processor indicating a status of said potential cardholder; and
printing said prepaid debit card at said point of sale in response to said authorization signal, wherein said printed prepaid debit card displays said identification indicia.

12) A method for immediate issuance of a prepaid debit Card according to claim 11, further comprising the step of:
transmitting a signal representing an interactive inquiry in order to further confirm the identity of said potential cardholder.

13) A method for immediate issuance of a prepaid debit card according to claim 11, further comprising the step of:
activating said prepaid debit card.

14) A method for immediate issuance of a prepaid debit card according to claim 13, wherein said step of activating said prepaid debit card comprises the selection and verification of a personal identification number.

15) A method for immediate issuance of a prepaid debit card according to claim 11, wherein said step of verifying the identity of said potential cardholder further includes analysis to determine whether said potential cardholder is eligible to obtain a prepaid debit card in accordance with Section 326 of the USA Patriot Act.

16) A system for issuance of a prepaid debit card having improved security measures to a potential cardholder, said system comprising:
a workstation for inputting information relating to said potential cardholder;
a scanner coupled to said workstation for capturing a digital image of documentary evidence provided by said potential cardholder;
a digital camera coupled to said workstation for capturing a digital photograph of said potential cardholder;
a network for transmitting said inputted information relating to said potential cardholder in real time to a processor;
a database containing publicly available information associated with the public-at-large coupled to said processor;
a memory coupled to said workstation for storing said information, digital image and photograph relating to said potential cardholder;
a PIN pad coupled to said workstation for receiving inputted information from said potential cardholder; and
a card printer coupled to said workstation for printing a prepaid debit card displaying said photograph and at least a portion of said information;
wherein said processor verifies the identity of the potential cardholder in real time by comparing said inputted information relating to said potential cardholder to data stored within said database.

17) A system for issuance of a prepaid debit card having improved security measures to a potential cardholder according to claim 16, wherein said processor further analyzes said information relating to said cardholder to determine whether said cardholder is eligible to receive a prepaid debit card.

18) A system for issuance of a prepaid debit card having improved security measures to a potential cardholder according to claim 17, wherein said determination whether said cardholder is eligible to receive a prepaid debit card complies with the obligations contained in Section 326 of the USA Patriot Act.
